(19) United States
(12) Patent Application Publication
(10) Pub. No.: US 2007/0184843 A1
(43) Pub. Date: Aug. 9, 2007

(54) Self surveying radio location method

(76) Inventor: Ian Sharp, New South Wales (AU)

Correspondence Address: LADAS & PARRY, 5670 WILSHIRE BOULEVARD, SUITE 2100, LOS ANGELES, CA, 90036-5679, US

(21) Appl. No.: 10/558,325

(22) PCT Filed: May 26, 2004
(86) PCT No.: PCT/AU04/00698

§ 371 Date: Oct. 26, 2006

(30) Foreign Application Priority Data
May 26, 2003 (AU) 2003902613

(51) Int. Cl. H04Q 7/20

(52) U.S. Cl. 455/456.1

(57) ABSTRACT

A method of determining the position of a plurality of a radio transmitter units relative to a master unit is disclosed in which a control signal is provided from the master unit commanding each of the radio transmitter units to transmit a test signal and the remaining units to receive. The arrival times of the test signals are measured at the receiving radio transmitter units, and the position of each radio transmitter unit relative to the master unit is calculated solely on the basis of the measured arrival times, and an approximate initial position for each unit.

### FIELD OF THE INVENTION

The present invention relates to a method of determining the geometric position of a plurality of radio transmitter units relative to a master unit. The method relates to the determination of relative positions of the units, although geographic positional (or grid) data may be optionally added to determine absolute positions. The invention extends to systems arranged to utilise such methods.

### BACKGROUND TO THE INVENTION

Radio location systems such as GPS are well known, and operate by dividing a system into “mobiles” whose position are to be determined and “fixed” components at known positions. For a tracking system, the location of mobile units is determined by measurement of the arrival times of signals received at the fixed units. For a navigation system (such as GPS) the transmitter and receiver elements are swapped, but the principle of position determination remains the same. There are many applications where GPS is not viable, particularly in indoor or multipath environments and there are many such environments in which there are possible applications for an accurate short range radio location system.

One possible application is the tracking of athletes on a sportsfield. This may be with a view to creating an animated display illustrating the positions of the athletes, or it may be in association with training activities, where the aim is to obtain biomedical data associated with fitness. In this case, the positional data are combined with medical sensor data to provide additional information not currently available from existing technology. As well as tracking athletes on a sportsfield, a similar radio location system could be used to monitor the position of race horses or racing cars on a track.

Another possible application for such a radio location system would be in the area of inventory control. The positional data could be combined with alarm monitoring functions based on inertial sensors. Potential applications include monitoring high worth items such as cars in warehouses, and monitoring containers in ships and container depots. Another slightly different application is associated with the monitoring of shopping trolleys in supermarkets. The functions in this application include trolley recovery outside the supermarket, as well as an aid to shopping within the supermarket.

A further possible application is for a personal locator. A radio location system could advantageously be used for tracking personnel in a building. Such a system may be required in a high security environment, or in an environment where personnel are carrying out hazardous activities. Monitoring the position of firefighters in a building is an example of such an application.

### SUMMARY OF THE INVENTION

According to one aspect of the present invention, a method of determining the position of a plurality of radio transmitter units relative to a master unit comprises the steps of:

providing a control signal from the master unit commanding each of the radio transmitter units to transmit a test signal and the remaining units to receive;

measuring the arrival times of the test signals at the receiving radio transmitter units; and

calculating the position of each radio transmitter unit relative to the master unit solely on the basis of the measured arrival times, and an approximate position for each unit.

Preferably, the control signal commands each of the radio transmitter units to transmit a test signal in turn and the remaining units to receive these signals. Preferably, a timing reference signal is also provided. Preferably, the master unit also provides the timing reference signal. This could be directly transmitted to all the other units from the master unit or may be sequentially transmitted from the master unit, to a first unit, then from the first unit to a second unit and so on.

The method utilises an approximate starting point and the arrival time data to calculate the positions of the units. The method is particularly useful for tracking systems whereby the previous position of each unit can be used as an approximate position each time a new position is calculated.

Implementation of the present invention can effectively be achieved in a method where the geometric positions of units can be determined solely on the time of arrival data from the initially unsynchronised radio transmitter units. The preferred technique is for each unit to transmit in sequence, and the signal is received at the remaining units. From the data set the relative positions of the units can be determined.

The system under consideration consists of transponder units distributed in a two-dimensional space. The problem is to determine the position of all the units relative to one another by solely using inter-unit radio communications. Because the method requires the orderly control of transmissions from each unit preferably in a time sequence, the control channel is required. A unit is defined as the master unit, from which the control messages are transmitted. The other “standard” units listen on the control channel for commands to either transmit or receive. The master unit also preferably provides a timing reference signal which can be used to define the appropriate time slots for the transmissions.

In one embodiment, the master unit does not act to transmit or receive test signals, but merely transmits the control signal and timing reference signal. In this case, preferably there are a minimum of seven additional “standard” units.

In another embodiment, the master unit also transmits and receives test signals, in addition to transmitting the control signal and timing reference signal, in which case a minimum of five “standard” units are required.

The positions of the remaining units can be determined relative to the master unit, which is defined to be at the origin without loss of generality for a relative positioning system. The position of a second unit is defined to be on the x-axis, again without loss of generality for a relative positioning system. Absolute positions on the earth, for example the Australian Map Grid (AMG), can be determined from the relative positions provided two points are defined on the AMG. These positions are surveyed using standard techniques.

Preferably, the step of calculating the position of the units comprises use of a least square fitting technique starting with an approximate position for the unit. The iterative procedure uses the initial position estimate as the input to the least-squares fitting process, with each iteration more closely approaching the true position. There are a number of possible ways of obtaining the initial position estimate. For instance, if tracking a horse or a car in a race, the starting point of the race may be used initially, and the last calculated position can be used for each subsequent calculation. Alternatively, the present inventors have found that an approximate starting point can be calculated by knowledge of the approximate transmit/receive radio equipment delay parameters of each unit.

The basic method of determining the unit locations is a least-square fitting technique similar in principle to that used for determining the positions of mobile units in a classical system where the positions of the fixed units are known. The technique uses an iterative procedure based on linearised ranging equations. This technique requires an approximate starting position for correct convergence. This initial position can be obtained using an approximate method which requires knowledge of transmit/receive delay parameters of the radio units. These delay parameters can be determined for the equipment to an accuracy of a few (say) tens of nanoseconds. Using the pseudo-range data and delay parameters, the distance between units can be estimated from the round-trip delay between two units. As the equipment delay is assumed to be known, the propagation delay (and hence the range in metres) can be calculated by subtracting the equipment delay and dividing by two. The accuracy of this initial estimate depends on the variability in the delay parameters between units. From these range estimates the positions of the units can be calculated using triangulation techniques. These approximate positions then can be used as a “seed” for the more accurate least-squares-position fitting technique. This position location method requires no input of unit delay parameters for the position determination, and thus will be more accurate than the triangulation technique.

### BRIEF DESCRIPTION OF THE DRAWING

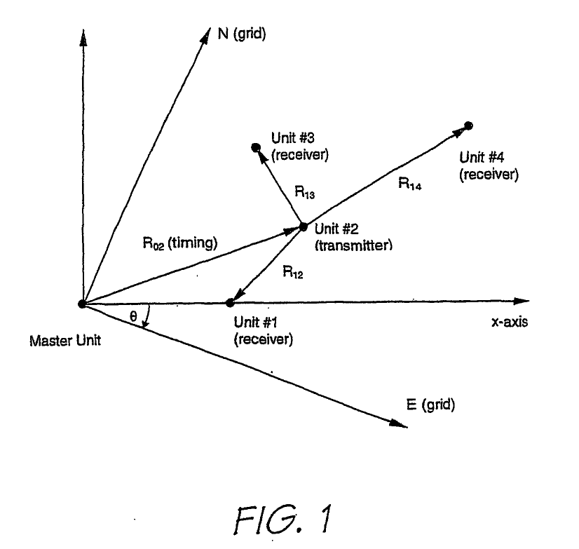

Preferred embodiments of the present invention will now be described with reference to FIG. 1 of the accompanying drawings, which illustrates the geometry of a system of four standard units and a master unit.

### DETAILED DESCRIPTION

The geometry of the system is as shown in FIG. 1. The master unit (timing reference transmitter) is located at the origin, and unit #1 is (arbitrarily) defined to lie along the x-axis. The y-axis is then normal to this defined x-axis. All other units are arbitrarily located in the xy-plane, but with the antennas located at a known height above the plane. The earth's grid coordinates will in general be rotated relative to the arbitrarily defined coordinate system based in the unit locations.

Initial Position Calculation

The initial position determination is based on estimating the ranges between the units. In the following case it is assumed that two units (the master unit and unit #1) are at known fixed positions relative to the earth, and it is required to determine the positions of the other units relative to these fixed units, and hence the earth.

Consider the geometry of the master unit and two other units (say #1 and #2). The standard units use the master unit timing reference signal to synchronise their local clocks. If the master unit clock phase is φ₀, then the clock phases φ₁, φ₂ in the other units are given by:
φ₁=φ₀+Δₘₛ^{tx}+R₁+Δ₁^{rx}
φ₂=φ₀+Δₘₛ^{tx}+R₂+Δ₂^{rx} (1)
where Δ^{tx} and Δ^{rx} are the transmit and receive delays of the units 1, 2, and master (ms) units.

The pseudo-range associated with unit #1 transmitting and unit #2 receiving is given by:
P₁₂=φ₁+Δ₁^{tx}+R₁₂+Δ₂^{rx}−φ₂=R₁₂+(R₁−R₂)+Δ₁
Δ₁=Δ₁^{tx}+Δ₂^{rx} (2)
Similarly, the pseudo-range associated with unit #2 transmitting and unit #1 receiving is given by:
P₂₁=φ₂+Δ₂^{tx}+R₁₂+Δ₂^{rx}−φ₁=R₁₂−(R₁−R₂)+Δ₂
Δ₂=Δ₂^{tx}+Δ₂^{rx} (3)
Thus by combining equations (2) and (3), the range between unit #1 and unit #2 is given by:

$${R}_{12} = [ \frac{{P}_{12} + {P}_{21}}{2} ] - [ \frac{{Δ}_{1} + {Δ}_{2}}{2} ] \approx [ \frac{{P}_{12} + {P}_{21}}{2} ] - {Δ}_{bs} \qquad ( 4 )$$

where Δ_{bs} is the average sum of the receive and transmit delays for the units (base station).

Thus from the pair of pseudo-range measurements plus knowledge of the delay parameters the inter-unit ranges can be estimated. It is normally assumed that all the units are the same, so that only the one parameter Δ_{bs} is required. However, the method is readily extended if the delay parameters are all different but of known values.

A similar analysis can be used to determine the master unit to standard unit ranges. The result (for unit #1) is:

$${R}_{1} = [ \frac{{P}_{01}}{2} ] - [ \frac{{Δ}_{1} + {Δ}_{m s}}{2} ] \approx [ \frac{{P}_{01}}{2} ] - [ \frac{{Δ}_{bs} + {Δ}_{m s}}{2} ] \qquad ( 5 )$$

where Δₘₛ is the sum of the transmit and receive delays for the master unit.

Thus the inter-unit ranges can be estimated from the pseudo-range measurement of the standard unit transmission at the master unit, plus knowledge of the unit delay parameters.

Having established estimates of the ranges, the relative positions of the units can be determined by triangularisation. The starting point in the calculation is the known positions of the master unit and unit #1 (assumed to be fixed units whose positions are known). The ranges from the master unit and unit #1 have been estimated (see above), so that the position of unit #2 can be determined by the intersection of two circles. In general there will be two solutions, one above the x-axis and one below the x-axis (or mirror images). This ambiguity cannot be resolved from the measured data, so that an operator input is required to select the correct solution.

The general solution for the intersection of two circles centred at (x₁, y₁) and (x₂, y₂) with radii r₁ and r₂ is given by the following set of equations:

$${d}_{1}^{2} = {x}_{1}^{2} + {y}_{1}^{2} - {r}_{1}^{2} \\ {d}_{2}^{2} = {x}_{2}^{2} + {y}_{2}^{2} - {r}_{2}^{2} \\ p = \frac{{y}_{1} - {y}_{2}}{{x}_{2} - {x}_{1}} \\ q = \frac{{d}_{1} - {d}_{2}}{2 ( {x}_{2} - {x}_{1} )} \\ u = 1 + {p}^{2} \\ v = 2 ( pq - {px}_{1} - {y}_{1} ) \\ w = {q}^{2} - 2 {qx}_{1} + {d}_{1} \\ {X}_{1} = {py}_{1} + q \\ {X}_{1} = {py}_{2} + q \\ {Y}_{1} = \frac{- v + \sqrt{{v}^{2} - 4 uw}}{2 u} \\ {Y}_{2} = \frac{v + \sqrt{{v}^{2} - 4 uw}}{2 u} \qquad ( 6 )$$

The above procedure can be repeated for the remaining units. However, the ambiguity can be solved by calculating the distance from unit #1 to the two potential positions of unit #2. The position with the smallest error between the calculated distance and the measured range is the correct position.

Thus the above procedure determines the positions of the units based on known positions of the master unit and unit #1, as well as the unit delay parameters. These positions are used to “seed” the least-squares solution, as described below.

Least-Squares Fitting Position Calculation

The accurate position of the units can be determined from just the pseudo-range data using a least-squares fitting technique. It is assumed that the locations of the master unit and unit #1 are known. For relative position determination, the master unit is assumed to be at the origin, and unit #1 on the x-axis. However, the method can be easily extended without any a priori position data for the master unit and unit #1, but only the relative positions can be determined.

The method of position determination uses pseudo-range data as measured at the standard units and the master unit One unit transmits at a time, so that the total number of measurements per transmission is (N−1) where N is the number of units (not including the master). The total number of measurements for all transmissions is N(N−1). Note in this scenario the master unit transmits also, but this is used the timing reference for the “standard” units. These data are used to calculate the position of the N units relative to the master unit at the origin. Further, as the unit #1 is assumed to be on the x-axis at a known position the number of unknown (x, y) position data are 2N−1. Additionally, as only pseudo-range data are measured, “phase” parameters for each unit must be also determined in the position determination calculations. Thus the total number of unknowns is 3N−1. The equipment delay parameters are also unknowns, but these unknowns can be eliminated from the equation, as shown in the following analysis. The determination of the number of units required to solve for the unknowns is given below.

Analysis of Method

Consider the case where there are N units. The units transmit one at a time (index t=1 . . . N), and the remaining units (r=1 . . . N, (r≠t)) receive the transmitted signal. The receiver measures the time difference between the unit transmitted signal and the timing reference signal transmitted by the master unit. The receiver path includes the propagation path from the transmitting antenna to the receiving antenna, plus the extra propagation delay from the receiving antenna to the output of the receiver. Also, the transmitter phase is assumed to be an unknown to be determined by the data processing. For convenience, all delays are assumed to be converted to the equivalent distance based on the speed of propagation. Thus the receiver measurement is given by:
M_{t,r}=φₜ+Δₜ^{tx}+R_{t,r}+Δᵣ^{rx}−φᵣ (7)
where the Δ terms are the transmitter or receiver delays from the antenna to the baseband clock, and the φ terms are the local clock phases in the transmitting and receiving units. These clocks are set from the timing reference signal transmitted from the master unit (see equation 1). Applying these clock expressions to equation 7 the resulting expression becomes:
M_{t,r}=R_{t,r}+(Rₜ−Rᵣ)+Δₜ=R_{t,r}−Rᵣ+Φₜ
Φⱼ=Δⱼ+Rⱼ (8)

Thus the measurement M_{t,r} can be expressed in terms of two ranges and a phase parameter associated with the transmitting unit only. Note that the equipment delay parameters do not appear in the equation, and thus the equation is closely related to the pseudo-range equations of classical position determination.

A similar analysis can be made for transmissions from a standard unit to the master unit The resulting equation is:
M_{t,ms}=2Rₜ+Δₜ+Δₘₛ=Rₜ+Φₜ+Δₘₛ (9)

For N standard units, a total of N(N−1) inter-unit measurements and N standard to master unit measurements are made (total of N² measurements). The number of unknowns are the (N−1) standard unit (x, y) positions, the y-coordinate of unit #1, the N phases Φ, and the master unit parameter Δₘₛ (total of 3N unknowns). Defining the unknown positions of the units (x, y), and letting the reference (master) unit be at the origin, the measurement predictor model is given by:

$$\begin{matrix}{P}_{t , r} = {R}_{t , r} - {R}_{r} + {Φ}_{t} \\ = \sqrt{{( {x}_{t} - {x}_{r} )}^{2} + {( {y}_{t} - {y}_{r} )}^{2} + {( {z}_{t} - {z}_{r} )}^{2}} - \\ \sqrt{{x}_{r}^{2} + {y}_{r}^{2} + {( {z}_{t} - {z}_{m s} )}^{2}} + {Φ}_{t}\end{matrix} \qquad ( 10 )$$

The terrain is assumed to be flat, so the heights (z) are simply the antenna heights above the ground. These antenna heights are assumed to be independently measured, and thus are not determined by this position determination process. Similarly the predictor equation for transmissions received at the master unit is:
P_{t,ms}=R_{t,ms}+Φₜ+Δₘₛ=\sqrt{xᵣ²+yᵣ²+(zₜ−zₘₛ)²}+Φₜ+Δₘₛ (11)

The problem now is to determine the least squares fit between the measurement equations M and the predictor equations P, thus solving for the unknowns. This task is complicated by the fact that the predictor equations are non-linear. The standard technique in such cases is to linearise the equation using a Taylor series approximation. Thus using the initial approximate estimate of the positions as described above (the phases initially can be assumed to be all zero), the predictor equation (10) can be written as:

$$\begin{matrix}{P}_{t , r} \approx {P}_{t , r}^{0} + \frac{\partial P}{\partial {x}_{t}} Δ {x}_{t} + \frac{\partial P}{\partial {x}_{r}} Δ {x}_{r} + \frac{\partial P}{\partial {y}_{t}} Δ {y}_{t} + \frac{\partial P}{\partial {y}_{r}} Δ {y}_{r} + \frac{\partial P}{\partial {ϕ}_{t}} Δ {Φ}_{t} \\ = {P}_{t , r}^{0} + \frac{{x}_{t} - {x}_{r}}{{R}_{t , r}^{0}} Δ {x}_{t} - [ \frac{{x}_{t} - {x}_{r}}{{R}_{t , r}^{0}} + \frac{{x}_{r}}{{R}_{0 , r}^{0}} ] Δ {x}_{r} + \\ \frac{{y}_{t} - {y}_{r}}{{R}_{t , r}^{0}} Δ {y}_{t} - [ \frac{{y}_{t} - {y}_{r}}{{R}_{t , r}^{0}} + \frac{{y}_{r}}{{R}_{0 , r}^{0}} ] Δ {y}_{r} + Δ {Φ}_{t}\end{matrix} \qquad ( 12 )$$

Similarly the linearised predictor equation for the master unit is:

$$\begin{matrix}{P}_{t , m s} \approx {P}_{t , m s}^{0} + \frac{\partial P}{\partial {x}_{t}} Δ {x}_{t} + \frac{\partial P}{\partial {y}_{t}} Δ {y}_{t} + \frac{\partial P}{\partial {ϕ}_{t}} Δ {Φ}_{t} \\ = {P}_{t , r}^{0} + \frac{{x}_{t}}{{R}_{t , m s}^{0}} Δ {x}_{t} + \frac{{y}_{t}}{{R}_{t , m s}^{0}} Δ {y}_{t} + Δ {Φ}_{t} + Δ {Φ}_{m s}\end{matrix} \qquad ( 13 )$$

The above linearised equations for prediction and measurements can be expressed in matrix form as follows:
[A][ΔX]=└M−P⁰┘ (14)
The [ΔX] matrix represents the 3N unknowns (state vector), where (x₀,y₀) is at the origin (master unit), and (x₁,y₁) is the position of unit #1 assumed to be on the x-axis. (Thus x₁ is the distance between the master unit and unit #1). However, these linear equations are not independent, so that an alternate set of equations can be derived which are independent. Consider the combining of the pseudo-range measurements associated with the inter-unit ranges R_{t,r} and R_{r,t} (which of course are the same distance). Thus the combined pseudo-range equation becomes:
M_{t,r}+M_{r,t}=μ_{t,r}=2R_{t,r}+Δₜ+Δᵣ (15)

By comparing equation 15 with equation 8 it can be observed that only the inter-unit ranges and the two unit delays occur in the combined equation, and thus these equations are independent. Notice also that equation 15 is similar in structure to equation 9, with (2 times) the range parameter and two delay parameters. Equation 15 can be linearised in a similar manner as described previously, resulting in the equation:

$$\begin{matrix}{P}_{t , r} \approx {P}_{t , r}^{0} + \frac{\partial P}{\partial {x}_{t}} Δ {x}_{t} + \frac{\partial P}{\partial {x}_{r}} Δ {x}_{r} + \frac{\partial P}{\partial {y}_{t}} Δ {y}_{t} + \frac{\partial P}{\partial {y}_{r}} Δ {y}_{r} + \\ \frac{\partial P}{\partial {ϕ}_{t}} Δ {Φ}_{t} + \frac{\partial P}{\partial {ϕ}_{t}} Δ {Φ}_{r} \\ = {P}_{t , r}^{0} + \frac{2 ( {x}_{t} - {x}_{r} )}{{R}_{t , r}^{0}} Δ {x}_{t} - \frac{2 ( {x}_{t} - {x}_{r} )}{{R}_{t , r}^{0}} Δ {x}_{r} + \\ \frac{2 ( {y}_{t} - {y}_{r} )}{{R}_{t , r}^{0}} Δ {y}_{t} - \frac{2 ( {y}_{t} - {y}_{r} )}{{R}_{t , r}^{0}} Δ {y}_{r} + Δ {Φ}_{t} + {ΔΦ}_{r}\end{matrix} \qquad ( 16 )$$

The alternative linearised equations can also be expressed in matrix form, namely:
[A][ΔX]=└μ−P⁰┘ (17)

Thus in both cases the unknown (increments) can be determined from a set of linear equations. In both cases the number of equations is greater than the number unknowns, so that a least-squares solution is required to obtain the best estimate. Assuming that the measurement errors are statistically independent, the standard least-squares solution to the linear equations represented by equation (14) is:
ΔX⁰=[A^{T}A]⁻¹A^{T}[M−P⁰] (18)

A similar expression applies to equation (17). However, the number of measurement equations is reduced from N(N+1) to N(N+1)/2.

The above least-squares estimate is based on the assumption that all the measurements are of equal accuracy. However, in a practical situations the measurements are corrupted by receiver noise and systematic errors associated with multipath propagation. In such circumstances the measurements should be weighted suitably, so that the least-squares equation becomes:
ΔX⁰=[A^{T}WA]⁻¹[A^{T}W][M−P⁰] (19)

The classical approach to determining the weighting matrix W is to assume independent random errors, so that the weighting matrix has diagonal components inversely proportional to the variance of the measurements noise, with all other elements zero. However, the normal operating environment will be dominated by multipath errors rather than random noise, so that the weighting matrix elements should be related to the multipath measurement errors (large errors are associated with a small weighting). The multipath measurement errors are not known a priori, but an estimate of the errors is the difference between the measured and predicted data, namely:
ΔM⁰=└M−P⁰┘ (20)

The weighting matrix now can be determined as follows. Initially all the elements of the weighting matrix are set to unity, and the initial measurement errors estimated from equation (19). The weighted error matrix is then:
δM⁰=W ΔM⁰ (21)

Define the standard of the diagonal elements of the weighted measurements as σₘ. If a measurement error is within ασₘ (where α is a constant, say 3), then leave the weighting elements unchanged; otherwise the measurement error is too large, so that the weighting of element “m” is reduced by an exponential factor, namely:

$${W}_{m , m} ⇒ {W}_{m , m} exp [ - {( \frac{δ {M}_{m}}{α {σ}_{m}} )}^{2} ] \qquad ( 22 )$$

The above procedure of adjustment of the weighting matrix is continued until the weighted error lies within α standard deviations. The consequence of the above process is that measurements are weighted according to the accuracy of the measurements, and thus a few “bad” measurements do not greatly affect the calculated positions.

The first order estimate of the state vector can be updated from the initial estimate:
X¹=X⁰+ΔX⁰ (23)
The above procedure is then repeated until the solution converges to the required accuracy. In practice, only about 3-5 iterations are required for the solution to converge to an accuracy of better than 1 millimetre. However, measurement errors (random and multipath) mean that converged solution will include both systematic (constant) and random components. The random component can be minimised by averaging multiple estimates of the state vectors from multiple measurements, but the systematic errors due mainly to multipath will remain. Thus the effect of multipath signals (mainly from ground reflections) is the main limitation in the accuracy of the position determination.

The relative positions of the units (as determined by the above procedure) can be readily converted to the grid, based on independently determined locations of the master unit and unit #1. If these grid coordinates (in Eastings and Northings) are (E₀, N₀) and (E₁, N₁), then the grid coordinates of the remaining units (n) are given by:
Eₙ, Nₙ=E₀+ΔEₙ, N₀+ΔNₙ
ΔEₙ=Xₓ cos θ−Yₙ sin θ
ΔNₙ=Xₙ sin θ+Yₙ cos θ
θ=tan⁻¹[(N₁−N₀)/(E₁−E₀)] (24)
Using equation 24, the units locations can be determined on the grid. Thus the (x, y) coordinate system used for tracking will be converted to the grid (E, N) coordinates, so that the unit positions are in grid coordinates. This coordinate system means that the unit positions can be overlaid onto a map (based in the grid).
Number of Units Required

The analysis above provides a solution, provided the number of unknowns (unit positions and phases) are less than the number of independent equations. The question remains—how many units (N) are required to obtain a solution. This section analyses the requirements for the number of units for various configurations of solutions.

The starting point for all estimates is the determination of the number of independent equations. It was shown above that the inter-unit distances are given by the equation:

$${R}_{t , r} = \frac{1}{2} [ {μ}_{t , r} - {Δ}_{t} - {Δ}_{r} ] \qquad ( 25 )$$

where “t” is the transmitter unit number and “r” is the receiver unit number. As the inter-unit distance is unique to each such equation, these equations are clearly independent. The number of such equations is N(N−1)/2 (N is the number of “standard” units), as the system is symmetrical if the transmitter and receiver are swapped.

In addition to using just standard units in the calculations, an option is to use the master unit as well. In this case there will be an extra N equations, or a total of N(N+1)/2.

The number of units can be determined for the various configurations, by defining the number of unknowns and relating this number to the number of equations. The redundancy (r) is defined as the excess between the number of independent equations and the number of unknowns.
1. Standard Units Only. In this scenario only N standard units are used to transmit and receive test signals with no absolute position data (relative positions only). The master unit is assumed to be at the origin and unit #1 on the x-axis. Each unit has three unknowns (x, y, Δ), except unit #1 which has only (x, Δ). Thus the number of unknowns is 3N−1, and the equation relating unknowns and variables is:

$$\frac{N ( N - 1 )}{2} \geq 3 N - 1 or {N}^{2} - 7 N + 2 \geq 0 \\ N \geq 7 r = 2 \qquad ( 26 )$$

where “r” is the number of redundant equations.
2. Standard Units Only (with grid data). In this scenario only standard units are used to transmit and receive test signals with grid data for the master and unit #1, thus providing absolute positions. The master unit is assumed to be at the origin and unit #1 at a known position on the x-axis. Each unit has three unknowns (x, y, Δ), except unit #1 which has only Δ. Thus the number of unknowns is 3N−2, and the equation relating unknowns and variables is:

$$\frac{N ( N - 1 )}{2} \geq 3 N - 2 or {N}^{2} - 7 N + 4 \geq 0 \\ N \geq 7 r = 4 \qquad ( 27 )$$
3. Standard/Master Units Only. In this scenario standard and master units are used to transmit and receive test signals with no grid data (relative positions only). The master unit is assumed to be at the origin and unit #1 on the x-axis. Each unit has three unknowns (x, y, Δ), except unit #1 which has only (x, Δ) and the master unit has only Δ. Thus the number of unknowns is 3N, and the equation relating unknowns and variables is:

$$\frac{N ( N + 1 )}{2} \geq 3 N or {N}^{2} - 5 N \geq 0 \\ N \geq 5 r = 0 \qquad ( 28 )$$
4. Base/Master Units (with grid data). In this scenario standard and master units are used to transmit and receive test signals with grid data for the master unit and unit #1, thus providing absolute positions. The master unit is assumed to be at the origin and unit #1 at a known position on the x-axis. Each unit has three unknowns (x, y, Δ), except the master unit and unit #1 which has only Δ. Thus the number of unknowns is 3N−1, and the equation relating unknowns and variables is:

$$\frac{N ( N + 1 )}{2} \geq 3 N - 1 or {N}^{2} - 5 N + 2 \geq 0 \\ N \geq 5 r = 2 \qquad ( 29 )$$

The results are summarised in the Table below. Notice that using the master unit (with or without grid data) reduces the number of units required by two rather than the naive expectation of a reduction of one unit. Adding grid data does not reduce the requirements for the number of units, but does provide absolute positions and added redundancy.

Table showing summary of the performance of different configurations.

| | Grid | | | |
|---|---|---|---|---|
| Type | Data | # Units | Redundancy | Comment |
| Std units only | No | 7 | 2 | Relative positions only. |
| Std units only | Yes | 7 | 4 | Relative positions only. |
| Std & | No | 5 | 0 | Absolute positions. No |
| master units | | | | redundancy check. |
| Std & | Yes | 5 | 2 | Absolute positions. |
| master units | | | | |

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that a reference herein to a prior art publication does not constitute an admission that the publication forms a part of the common general knowledge in the art in Australia, or any other country.

1. A method of determining the position of a plurality of a radio transmitter units relative to a master unit comprising the steps of:
providing a control signal from the master unit commanding each of the radio transmitter units to transmit a test signal and the remaining units to receive;
measuring the arrival times of the test signals at the receiving radio transmitter units; and
calculating the position of each radio transmitter unit relative to the master unit solely on the basis of the measured arrival times, and an approximate initial position for each unit.

2. A method according to claim 1, wherein the control signal commands each of the radio transmitter units to transmit a test signal in turn.

3. A method according to claim 2, wherein a timing reference signal is also provided.

4. A method according to claim 3, wherein the master unit also provides the timing reference signal.

5. A method according to claim 1, wherein the master unit does not act to transmit or receive test signals.

6. A method according to claim 1, wherein the master unit also transmits and receives test signals.

7. A method according to claim 5, wherein measurements between at least seven units are utilised.

8. A method according to claim 6, wherein measurements between at least five units are utilised.

9. A method according to claim 1, comprising the step of determining a grid position of each unit from the grid positions of any two other units.

10. A method according to claim 1, wherein the step of calculating the position of each radio transmitter unit comprises use of a least square fitting technique starting with an approximate position for each unit.

11. A method according to claim 1, wherein the approximate starting position for each unit is calculated using the approximate transmit/receive delay parameters of each unit.

12. A system for position monitoring comprising:
a master unit; and
a plurality of radio transmitter units, wherein the master unit includes means for providing a control signal commanding each of the radio transmitter units to transmit a test signal and the remaining units to receive;
the system further comprising means for measuring the arrival times of the test signals at the receiving radio transmitter units and means for calculating the position of each radio transmitter unit relative to the master unit solely on the basis of the measured arrival times and an approximate starting position for each radio transmitter unit.
